(19) United States
(12) Patent Application Publication
(10) Pub. No.: US 2016/0110437 A1
(43) Pub. Date: Apr. 21, 2016

(54) ACTIVITY STREAM

(71) Applicant: Kaybus, Inc., San Francisco, CA (US)

(72) Inventors: Mehul Patel, Saratoga, CA (US); Tao Liang, Palo Alto, CA (US)

(21) Appl. No.: 14/885,487

(22) Filed: Oct. 16, 2015

Related U.S. Application Data
(60) Provisional application No. 62/065,605, filed on Oct. 17, 2014.
(60) Provisional application No. 62/065,603, filed on Oct. 17, 2014.

(51) Int. Cl. G06F 17/30; G06F 3/0482; G06F 3/0484

(52) U.S. Cl. CPC G06F 17/30572; G06F 17/30554; G06F 3/04847; G06F 3/0482

(57) ABSTRACT

Knowledge automation techniques may include monitoring user interactions of a user and identifying user interest patterns of the user based on the user interactions. A set of knowledge elements of interest to the user can be determined based on the user interest patterns. Metadata changes associated with the set of knowledge elements of interest to the user can be detected, and the metadata changes can then be displayed to the user to inform the user of activities conducted on the set of knowledge elements.

### CROSS-REFERENCES TO RELATED APPLICATIONS

The present application is a non-provisional of and claims the benefit and priority of U.S. Provisional Application No. 62/065,605, filed Oct. 17, 2014, entitled “Activity Stream,” and U.S. Provisional Application No. 62/065,603, filed Oct. 17, 2014, entitled “Techniques for Mapping Knowledge to Users within a Knowledge System,” the entire contents of both of which are incorporated herein by reference for all purposes.

### BACKGROUND

The present disclosure generally relates to knowledge automation. More particularly, techniques are disclosed for generation of knowledge campaigns and tracking the consumption progress of knowledge campaigns.

With the vast amount of data content available, users often suffer from information overload. For example, in an enterprise environment, a large corporation may store all the data that users need to complete their tasks. However, finding the right data for the right user can be challenging. Users may often spend substantial amount of time looking for a needle in a haystack in trying to find the right data to fill their particular needs from thousands of data files. In a collaborative environment, even after the right data is found, substantial amount of time may be needed to synthesis that data into a suitable output that can be consumed by others. The amount of time that users spend searching and synthesizing the data may also create excessive load on the enterprise computing systems and slow down the processing of other tasks.

In traditional training and learning environments, relevant training materials are manually defined by a supervisor or an instructor. This can lead to inconsistent results, such as conflicting or inadequate information disseminated by different supervisors or instructors. Furthermore, for information disseminated to users via a computer network (e.g., web-based training materials), it can be difficult to track the progress of how much material each user has gone through.

Embodiments of the present invention address these and other problems individually and collectively

### BRIEF SUMMARY

The present disclosure generally relates to knowledge automation. More particularly, knowledge automation techniques are disclosed for streaming activities relating to knowledge elements that are of interest to a user.

In some embodiments, the techniques may include monitoring user interactions of a user such as search queries submitted by the user, consumption of knowledge elements by the user, and publication of knowledge elements to the system by the user. User interactions by other users belonging to the same user group as the user can also be monitored. User interest patterns of the user can be identified based on the user interactions of the user and/or user interactions by other users belong to the same user group, and a set of knowledge elements of interest to the user can be determined based on the user interest patterns. The set of knowledge elements of interest to the user may include knowledge elements consumed and/or published by the user, as well as knowledge elements that the user has not consumed or published. Metadata changes associated with the set of knowledge elements of interest to the user can be detected, and be displayed to the user to inform the user of activities conducted on the set of knowledge elements. The metadata changes may include activities such as a new user comment posted for a knowledge element in the set of knowledge elements of interest to the user, a new user rating on a knowledge element in the set of knowledge elements of interest to the user, and content update associated with a knowledge element in set of knowledge elements of interest to the user.

In some embodiments, certain techniques may include dynamically adjusting the user interest patterns of the user based on subsequent user interactions of the user. The set of knowledge elements of interest to the user can be updated based on the adjusted user interest patterns, and the metadata changes being displayed can be modified based on the updated set of knowledge elements of interest to the user.

In some embodiments, certain techniques may include displaying the user interest patterns of the user on a graphical user interface that allows the user to adjust an interest level of one or more of the user interest patterns. When user input adjusting the interest level of one or more of the user interest patterns is received, the set of knowledge elements of interest to the user can be updated based on the adjusted interest level, and the metadata changes being displayed can be modified based on the updated set of knowledge elements of interest to the user.

In some embodiments, a non-transitory computer-readable storage memory may store a plurality of instructions executable by one or more processors. The plurality of instructions may include instructions to perform the techniques described above. In some embodiments, a system may include one or more processors, and a memory coupled with and readable by the one or more processors. The memory can be configured to store a set of instructions which, when executed by the one or more processors, causes the one or more processors to perform the techniques described above.

### BRIEF DESCRIPTION OF THE DRAWINGS

FIG. 1 illustrates an environment in which a knowledge automation system can be implemented, according to some embodiments.

FIG. 2 illustrates a flow diagram depicting some of the processing that can be performed by a knowledge automation system, according to some embodiments.

FIG. 3 illustrates a block diagram of a knowledge automation system, according to some embodiments.

FIG. 4 illustrates a user profile, according to some embodiments.

FIG. 5 illustrates a user profile group, according to some embodiments.

FIG. 6 illustrates an example formation of a knowledge pack, according to some embodiments.

FIG. 7 illustrates a knowledge bank, according to some embodiments.

FIG. 8 illustrates a flow diagram of a knowledge mapping process, according to some embodiments.

FIG. 9 illustrates a diagram of a user's interest level in identified content and a graphical user interface for adjusting the interest levels, according to some embodiments.

FIG. 10 illustrates a flow diagram of an activity streaming process, according to some embodiments.

FIG. 11 illustrates a graphical user interface for displaying metadata changes, according to some embodiments.

FIG. 12 illustrates another graphical user interface for displaying metadata changes, according to some embodiments.

FIG. 13 illustrates a further graphical user interface for displaying metadata changes, according to some embodiments.

FIG. 14 illustrates a flow diagram of a process for adjusting user interest patterns based on user interactions, according to some embodiments.

FIG. 15 illustrates a flow diagram of a process for adjusting user interest patterns based on user feedback, according to some embodiments.

FIG. 16 depicts a block diagram of a computing system, according to some embodiments

FIG. 17 depicts a block diagram of a service provider system, according to some embodiments.

### DETAILED DESCRIPTION

The present disclosure relates generally to knowledge automation. Certain techniques are disclosed for streaming activities related to knowledge elements that are of interest to a user.

Substantial amounts of data (e.g., data files such as documents, emails, images, code, and other content, etc.) may be available to users in an enterprise. These users may rely on information contained in the data to assist them in performing their tasks. The users may also rely on information contained in the data to generate useful knowledge that is consumed by other users. For example, a team of users may take technical specifications related to a new product release, and generate a set of training materials for the technicians who will install the new product. However, the large quantities of data available to these users may make it difficult to identify the right information to use.

Machine learning techniques can analyze content at scale (e.g., enterprise-wide and beyond) and identify patterns of what is most useful to which users. Machine learning can be used to model both the content accessible by an enterprise system (e.g., local storage, remote storage, and cloud storage services, such as SharePoint, Google Drive, Box, etc.), and the users who request, view, and otherwise interact with the content. Based on a user's profile and how the user interacts with the available content, each user's interests, expertise, and peers can be modeled. The data content can then be matched to the appropriate users who would most likely be interested in that content. In this manner, the right knowledge can be provided to the right users at the right time. This not only improves the efficiency of the users in identifying and consuming knowledge relevant for each user, but also improves the efficiency of computing systems by freeing up computing resources that would otherwise be consumed by efforts to search and locate the right knowledge, and allowing these computing resources to be allocated for other tasks.

### I. Architecture Overview

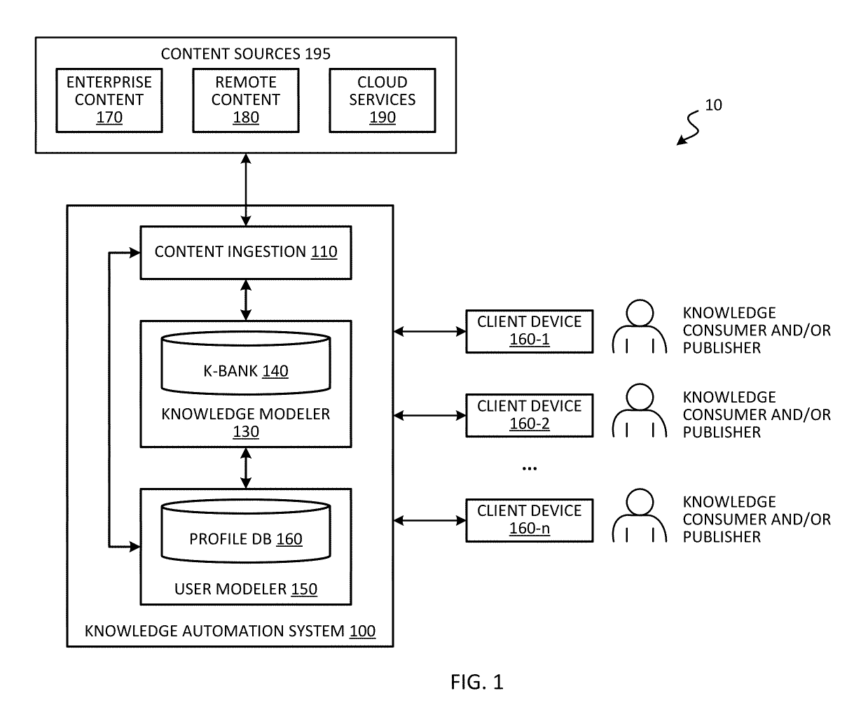

FIG. 1 illustrates an environment 10 in which a knowledge automation system 100 can be implemented, according to some embodiments. As shown in FIG. 1, a number of client devices 160-1, 160-2, . . . 160-n can be used by a number of users to access services provided by knowledge automation system 100. The client devices may be of various different types, including, but not limited to personal computers, desktops, mobile or handheld devices such as laptops, smart phones, tablets, etc., and other types of devices. Each of the users can be a knowledge consumer who accesses knowledge from knowledge automation system 100, or a knowledge publisher who publishes or generates knowledge in knowledge automation system 100 for consumption by other users. In some embodiments, a user can be both a knowledge consumer or a knowledge publisher, and a knowledge consumer or a knowledge publisher may refer to a single user or a user group that includes multiple users.

Knowledge automation system 100 can be implemented as a data processing system, and may discover and analyze content from one or more content sources 195 stored in one or more data repositories, such as a databases, file systems, management systems, email servers, object stores, and/or other repositories or data stores. In some embodiments, client devices 160-1, 160-2, . . . 160-n can access the services provided by knowledge automation system 100 through a network such as the Internet, a wide area network (WAN), a local area network (LAN), an Ethernet network, a public or private network, a wired network, a wireless network, or a combination thereof. Content sources 195 may include enterprise content 170 maintained by an enterprise, remote content 180 maintained at one or more remote locations (e.g., the Internet), cloud services content 190 maintained by cloud storage service providers, etc. Content sources 195 can be accessible to knowledge automation system 100 through a local interface, or through a network interface connecting knowledge automation system 100 to the content sources via one or more of the networks described above. In some embodiments, one or more of the content sources 195, one or more of the client devices 160-1, 160-2, . . . 160-n, and knowledge automation system 100 can be part of the same network, or can be part of different networks.

Each client device can request and receive knowledge automation services from knowledge automation system 100. Knowledge automation system 100 may include various software applications that provide knowledge-based services to the client devices. In some embodiments, the client devices can access knowledge automation system 100 through a thin client or web browser executing on each client device. Such software as a service (SaaS) models allow multiple different clients (e.g., clients corresponding to different customer entities) to receive services provided by the software applications without installing, hosting, and maintaining the software themselves on the client device.

Knowledge automation system 100 may include a content ingestion module 110, a knowledge modeler 130, and a user modeler 150, which collectively may extract information from data content accessible from content sources 195, derive knowledge from the extracted information, and provide recommendation of particular knowledge to particular clients. Knowledge automation system 100 can provide a number of knowledge services based on the ingested content. For example, a corporate dictionary can automatically be generated, maintained, and shared among users in the enterprise. A user's interest patterns (e.g., the content the user typically views) can be identified and used to provide personalized search results to the user. In some embodiments, user requests can be monitored to detect missing content, and knowledge automation system 100 may perform knowledge brokering to fill these knowledge gaps. In some embodiments, users can define knowledge campaigns to generate and distribute content to users in an enterprise, monitor the usefulness of the content to the users, and make changes to the content to improve its usefulness.

Content ingestion module 110 can identify and analyze enterprise content 170 (e.g., files and documents, other data such as e-mails, web pages, enterprise records, code, etc. maintained by the enterprise), remote content 180 (e.g., files, documents, and other data, etc. stored in remote databases), cloud services content 190 (e.g., files, documents, and other data, etc. accessible form the cloud), and/or content from other sources. For example, content ingestion module 110 may crawl or mine one or more of the content sources to identify the content stored therein, and/or monitor the content sources to identify content as they are being modified or added to the content sources. Content ingestion module 110 may parse and synthesize the content to identify the information contained in the content and the relationships of such information. In some embodiments, ingestion can include normalizing the content into a common format, and storing the content as one or more knowledge units in a knowledge bank 140 (e.g., a knowledge data store). In some embodiments, content can be divided into one or more portions during ingestion. For example, a new product manual may describe a number of new features associated with a new product launch. During ingestion, those portions of the product manual directed to the new features may be extracted from the manual and stored as separate knowledge units. These knowledge units can be tagged or otherwise be associated with metadata that can be used to indicate that these knowledge units are related to the new product features. In some embodiments, content ingestion module 110 may also perform access control mapping to restrict certain users from being able to access certain knowledge units.

Knowledge modeler 130 may analyze the knowledge units generated by content ingestion module 120, and combine or group knowledge units together to form knowledge packs. A knowledge pack may include various related knowledge units (e.g., several knowledge units related to a new product launch can be combined into a new product knowledge pack). In some embodiments, a knowledge pack can be formed by combining other knowledge packs, or a mixture of knowledge unit(s) and knowledge pack(s). The knowledge packs can be stored in knowledge bank 140 together with the knowledge units, or be stored separately. Knowledge modeler 130 may automatically generate knowledge packs by analyzing the topics covered by each knowledge unit, and combining knowledge units covering a similar topic into a knowledge pack. In some embodiments, knowledge modeler 130 may allow a user (e.g., a knowledge publisher) to build custom knowledge packs, and to publish custom knowledge packs for consumption by other users.

User modeler 150 may monitor user activities on the system as they interact with the knowledge bank 140 and the knowledge units and knowledge packs stored therein (e.g., the user's search history, knowledge units and knowledge packs consumed, knowledge packs published, time spent viewing each knowledge pack and/or search results, etc.). User modeler 150 may maintain a profile database 160 that stores user profiles for users of knowledge automation system 100. User modeler 150 may augment the user profiles with behavioral information based on user activities. By analyzing the user profile information, user modeler 150 can match a particular user to knowledge packs that the user may be interested in, and provide the recommendations to that user. For example, if a user has a recent history of viewing knowledge packs directed to a wireless networks, user modeler module 150 may recommend other knowledge packs directed to wireless networks to the user. As the user interacts with the system, user modeler 150 can dynamically modify the recommendations based on the user's behavior. User modeler 150 may also analyze search results performed by users to determine the effectiveness of the search results (e.g., did the user select and use the results), and to identify potential knowledge gaps in the system. In some embodiments, user modeler 150 may provide these knowledge gaps to content ingestion module 310 to find useful content to fill the knowledge gaps.

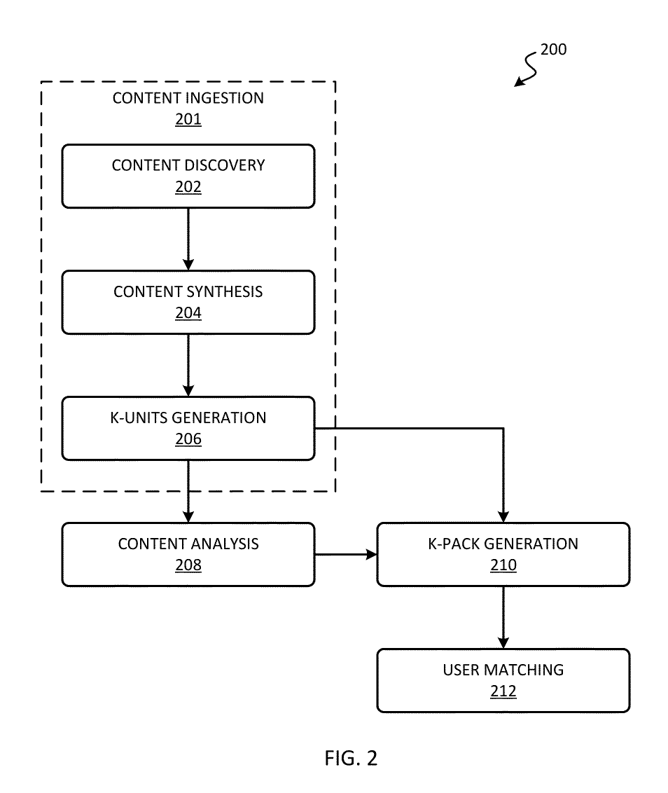

FIG. 2 illustrates a simplified flow diagram 200 depicting some of the processing that can be performed, for example, by a knowledge automation system, according to some embodiments. The processing depicted in FIG. 2 may be implemented in software (e.g., code, instructions, program) executed by one or more processing units (e.g., processors, cores), hardware, or combinations thereof. The software may be stored in memory (e.g., on a non-transitory computer-readable storage medium such as a memory device).

The processing illustrated in flow diagram 200 may begin with content ingestion 201. Content ingestion 201 may include content discovery 202, content synthesis 204, and knowledge units generation 206. Content ingestion 201 can be initiated at block 202 by performing content discovery to identify and discover data content (e.g., data files) at one or more data sources such as one or more data repositories. At block 204, content synthesis is performed on the discovered data content to identify information contained in the content. The content synthesis may analyze text, patterns, and metadata variables of the data content.

At block 206, knowledge units are generated from the data content based on the synthesized content. Each knowledge unit may represent a chunk of information that covers one or more related subjects. The knowledge units can be of varying sizes. For example, each knowledge unit may correspond to a portion of a data file (e.g., a section of a document) or to an entire data file (e.g., an entire document, an image, etc.). In some embodiments, multiple portions of data files or multiple data files can also be merged to generate a knowledge unit. By way of example, if an entire document is focused on a particular subject, a knowledge unit corresponding to the entire document can be generated. If different sections of a document are focused on different subjects, then different knowledge units can be generated from the different sections of the document. A single document may also result in both a knowledge unit generated for the entire document as well as knowledge units generated from portions of the document. As another example, various email threads relating to a common subject can be merged into a knowledge unit. The generated knowledge units are then indexed and stored in a searchable knowledge bank.

At block 208, content analysis is performed on the knowledge units. The content analysis may include performing semantics and linguistics analyses and/or contextual analysis on the knowledge units to infer concepts and topics covered by the knowledge units. Key terms (e.g., keywords and key phrases) can be extracted, and each knowledge unit can be associated with a term vector of key terms representing the content of the knowledge unit. In some embodiments, named entities can be identified from the extracted key terms. Examples of named entities may include place names, people's names, phone numbers, social security numbers, business names, dates and time values, etc. Knowledge units covering similar concepts can be clustered, categorized, and tagged as pertaining to a particular topic or topics. Taxonomy generation can also be performed to derive a corporate dictionary identifying key terms and how the key terms are used within an enterprise.

At block 210, knowledge packs are generated from individual knowledge units. The knowledge packs can be automatically generated by combining knowledge units based on similarity mapping of key terms, topics, concepts, metadata such as authors, etc. In some embodiments, a knowledge publisher can also access the knowledge units generated at block 206 to build custom knowledge packs. A knowledge map representing relationships between the knowledge packs can also be generated to provide a graphical representation of the knowledge corpus in an enterprise.

At block 212, the generated knowledge packs are mapped to knowledge consumers who are likely to be interested in the particular knowledge packs. This mapping can be performed based on information about the user (e.g., user's title, job function, etc.), as well as learned behavior of the user interacting with the system (e.g., knowledge packs that the user has viewed and consumed in the past, etc.). The user mapping can also take into account user feedback (e.g., adjusting relative interest levels, search queries, ratings, etc.) to tailor future results for the user. Knowledge packs mapped to a particular knowledge consumer can be distributed to the knowledge consumer by presenting the knowledge packs on a recommendations page for the knowledge consumer.

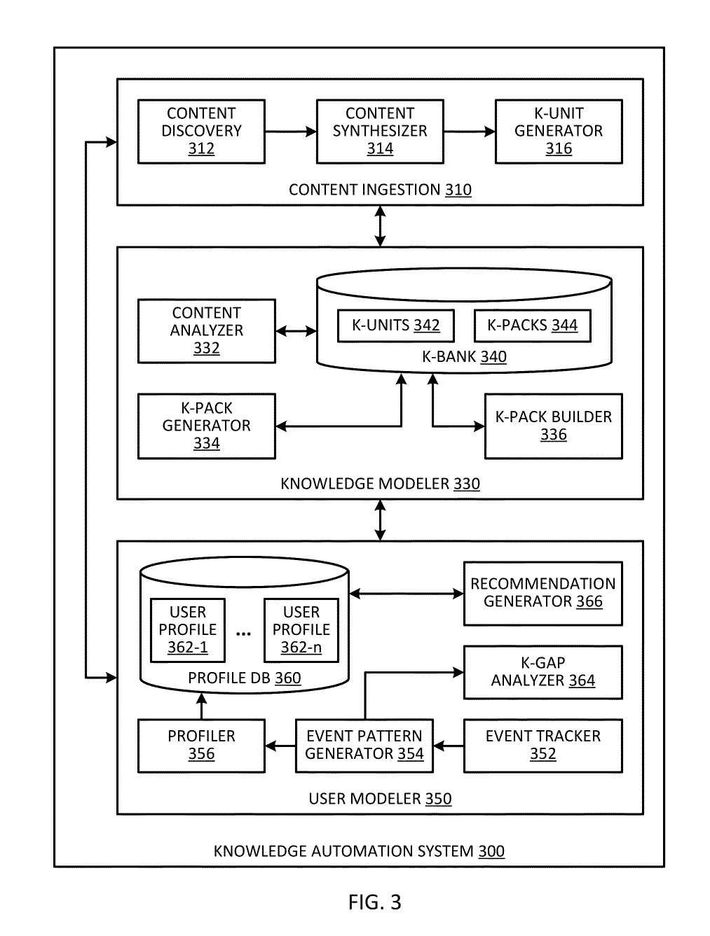

FIG. 3 illustrates a more detailed block diagram of a knowledge automation system 300, according to some embodiments. Knowledge automation system 300 can be implemented as a data processing system, and may include a content ingestion module 310, a knowledge modeler 330, and a user modeler 350. In some embodiments, the processes performed by knowledge automation system 300 can be performed in real-time. For example, as the data content or knowledge corpus available to the knowledge automation system changes, knowledge automation system 300 may react in real-time and adapt its services to reflect the modified knowledge corpus.

Content ingestion module 310 may include a content discovery module 312, a content synthesizer 314, and a knowledge unit generator 316. Content discovery module 312 interfaces with one or more content sources to discover contents stored at the content sources, and to retrieve the content for analysis. In some embodiments, knowledge automation system 300 can be deployed to an enterprise that already has a pre-existing content library. In such scenarios, content discovery module 312 can crawl or mine the content library for existing data files, and retrieve the data files for ingestion. In some embodiments, the content sources can be continuously monitored to detect the addition, removal, and/or updating of content. When new content is added to a content source or a pre-existing content is updated or modified, content discovery module 312 may retrieve the new or updated content for analysis. New content may result in new knowledge units being generated, and updated content may result in modifications being made to affected knowledge units and/or new knowledge units being generated. When content is removed from a content source, content discovery module 312 may identify the knowledge units that were derived from the removed content, and either remove the affected knowledge units from the knowledge bank, or tag the affected knowledge units as being potentially invalid or outdated.

Content synthesizer 314 receives content retrieved by content discovery module 312, and synthesizes the content to extract information contained in the content. The content retrieved by content discovery module 312 may include different types of content having different formats, storage requirements, etc. As such, content synthesizer 314 may convert the content into a common format for analysis. Content synthesizer 314 may identify key terms (e.g., keywords and/or key phrases) in the content, determine a frequency of occurrence of the key terms in the content, and determining locations of the key terms in the content. In addition to analyzing information contained in the content, content synthesizer 314 may also extract metadata associated with the content (e.g., author, creation date, title, revision history, etc.).

Knowledge unit generator 314 may then generate knowledge units from the content based on patterns of key terms used in the content and the metadata associated with the content. For example, if a document has a large frequency of occurrence of a key term in the first three paragraphs of the document, but a much lower frequency of occurrence of that same key term in the remaining portions of the document, the first three paragraphs of the document can be extracted and formed into a knowledge unit. As another example, if there is a large frequency of occurrence of a key term distributed throughout a document, the entire document can be formed into a knowledge unit. The generated knowledge units are stored in a knowledge bank 340, and indexed based on the identified key terms and metadata to make the knowledge units searchable in knowledge bank 340.

Knowledge modeler 330 may include content analyzer 332, knowledge bank 340, knowledge pack generator 334, and knowledge pack builder 336. Content analyzer 332 may perform various types of analyses on the knowledge units to model the knowledge contained in the knowledge units. For example, content analyzer 332 may perform key term extraction and entity (e.g., names, companies, organizations, etc.) extraction on the knowledge units, and build a taxonomy of key terms and entities representing how the key terms and entities are used in the knowledge units. Content analyzer 332 may also perform contextual, sematic, and linguistic analyses on the knowledge units to infer concepts and topics covered by the knowledge units. For example, natural language processing can be performed on the knowledge units to derive concepts and topics covered by the knowledge units. Based on the various analyses, content analyzer 332 may derive a term vector for each knowledge unit to represent the knowledge contained in each knowledge unit. The term vector for a knowledge unit may include key terms, entities, and dates associated with the knowledge unit, topic and concepts associated with the knowledge unit, and/or other metadata such as authors associated with the knowledge unit. Using the term vectors, content analyzer 332 may perform similarity mapping between the knowledge units to identify knowledge units that cover similar topics or concepts.

Knowledge pack generator 334 may analyze the similarity mapping performed by content analyzer 332, and automatically form knowledge packs by combining similar knowledge units. For example, knowledge units that share at least five common key terms can be combined to form a knowledge pack. As another example, knowledge units covering the same topic can be combined to form a knowledge pack. In some embodiments, a knowledge pack may include other knowledge packs, or a combination of knowledge pack(s) and knowledge unit(s). For example, knowledge packs that are viewed and consumed by the a set of users can be combined into a knowledge pack. The generated knowledge packs can be tagged with their own term vectors to represent the knowledge contain in the knowledge pack, and be stored in knowledge bank 340.

Knowledge pack builder 336 may provide a user interface to allow knowledge publishers to create custom knowledge packs. Knowledge pack builder 336 may present a list of available knowledge units to a knowledge publisher to allow the knowledge publisher to select specific knowledge units to include in a knowledge pack. In this manner, a knowledge publisher can create a knowledge pack targeted to specific knowledge consumers. For example, a technical trainer can create a custom knowledge pack containing knowledge units covering specific new features of a produce to train a technical support staff. The custom knowledge packs can also be tagged and stored in knowledge bank 340.

Knowledge bank 340 is used for storing knowledge units 342 and knowledge packs 344. Knowledge bank 340 can be implemented as one or more data stores. Although knowledge bank 340 is shown as being local to knowledge automation system 300, in some embodiments, knowledge bank 340, or part of knowledge bank 340 can be remote to knowledge automation system 300. In some embodiments, frequently requested, or otherwise highly active or valuable knowledge units and/or knowledge packs, can be maintained in in a low latency, multiple redundancy data store. This makes the knowledge units and/or knowledge packs quickly available when requested by a user. Infrequently accessed knowledge units and/or knowledge packs may be stored separately in slower storage.

Each knowledge unit and knowledge pack can be assigned an identifier that is used to identify and access the knowledge unit or knowledge pack. In some embodiments, to reduce memory usage, instead of storing the actual content of each knowledge unit in knowledge bank 340, the knowledge unit identifier referencing the knowledge unit and the location of the content source of the content associated with the knowledge unit can be stored. In this manner, when a knowledge unit is accessed, the content associated with the knowledge unit can be retrieved from the corresponding content source. For a knowledge pack, an knowledge pack identifier referencing the knowledge pack, and the identifiers and locations of the knowledge units and/or knowledge packs that make up the knowledge pack can be stored. Thus, a particular knowledge pack can be thought of as a container or a wrapper object for the knowledge units and/or knowledge packs that make up the particular knowledge pack. In some embodiments, knowledge bank 340 may also store the actual content of the knowledge units, for example, in a common data format. In some embodiments, knowledge bank 340 may selectively store some content while not storing other content (e.g., content of new or frequently accessed knowledge units can be stored, whereas stale or less frequently accessed content are not stored in knowledge bank 340).

Knowledge units 342 can be indexed in knowledge bank 340 according to key terms contained in the knowledge unit (e.g., may include key words, key phrases, entities, dates, etc. and number of occurrences of such in the knowledge unit) and/or associated metadata (e.g., author, location such as URL or identifier of the content, date, language, subject, title, file or document type, etc.). In some embodiments, the metadata associated with a knowledge unit may also include metadata derived by knowledge automation system 300. For example, this may include information such as access control information (e.g., which user or user group can view the knowledge unit), topics and concepts covered by the knowledge unit, knowledge consumers who have viewed and consumed the knowledge unit, knowledge packs that the knowledge unit is part of, time and frequency of access, etc.). Knowledge packs 344 stored in knowledge bank may include knowledge packs automatically generated by the system, and/or custom knowledge packs created by users (e.g., knowledge publishers). Knowledge packs 344 may also be indexed in a similar manner as for knowledge packs described above. In some embodiments, the metadata for a knowledge pack may include additional information that a knowledge unit may not have. For example, these may include a category type (e.g., newsletter, emailer, training material, etc.), editors, target audience, etc.

In some embodiments, a term vector can be associated with each knowledge element (e.g., a knowledge unit and/or a knowledge pack). The term vector may include key terms, metadata, and derived metadata associated with the each knowledge element. In some embodiments, instead of including all key terms present in a knowledge element, the term vector may include a predetermined number of key terms with the highest occurrence count in the knowledge element (e.g., the top five key terms in the knowledge element, etc.), or key terms that have greater than a minimum number of occurrences (e.g., key terms that appear more than ten times in a knowledge element, etc.). In some embodiments, the metadata associated with a knowledge element may also include user comment about the knowledge element that a user submitted to the system, user rating of the knowledge element, a revision history of the knowledge element, and the associated content updates made to the knowledge element.

User modeler 350 may include an event tracker 352, an event pattern generator 354, a profiler 356, a knowledge gap analyzer 364, a recommendations generator 366, and a profile database 360 that stores a user profile for each user of knowledge automation system 300. Event tracker 352 monitors user activities and interactions with knowledge automation system 300. For example, the user activities and interactions may include knowledge consumption information such as which knowledge unit or knowledge pack that a user has viewed or consumed, the length of time spent on the knowledge unit/pack, and when did the user access the knowledge unit/pack. The user activities and interactions tracked by event tracker 352 may also include search queries performed by the users, and user responses to the search results (e.g., number and frequency of similar searches performed by the same user and by other users, amount of time a user spends on reviewing the search result, how deep into a result list the user traversed, the number of items in the result list the user accessed and length of time spend on each item, etc.). If a user is a knowledge publisher, event tracker 352 may also track the frequency that the knowledge publisher publishes, when the knowledge publisher publishes, and topics or categories that the knowledge publisher publishes in, etc.

Event pattern generator 354 may analyze the user activities and interactions tracked by event tracker 352, and derive usage or event patterns for users or user groups. Profiler 356 may analyze these patterns and augment the user profiles stored in profile database 360. For example, if a user has a recent history of accessing a large number of knowledge packs relating to a particular topic, profiler 356 may augment the user profile of this user with an indication that this user has an interest in the particular topic. For patterns relating to search queries, knowledge gap analyzer 364 may analyze the search query patterns and identify potential knowledge gaps relating to certain topics in which useful information may be lacking in the knowledge corpus. Knowledge gap analyzer 364 may also identify potential content sources to fill the identified knowledge gaps. For example, a potential content source that may fill a knowledge gap can be a knowledge publisher who frequently publishes in a related topic, the Internet, or some other source from which information pertaining to the knowledge gap topic can be obtained.

Recommendations generator 366 may provide a knowledge mapping service that provides knowledge pack recommendations to knowledge consumers of knowledge automation system 300. Recommendations generator 366 may compare the user profile of a user with the available knowledge packs in knowledge bank 340, and based on the interests of the user, recommend knowledge packs to the user that may be relevant for the user. For example, when a new product is released and a product training knowledge pack is published for the new product, recommendations generator 366 may identify knowledge consumers who are part of a sales team, and recommend the product training knowledge pack to those users. In some embodiments, recommendations generator 366 may generate user signatures form the user profiles and knowledge signatures from the knowledge elements (e.g., knowledge units and/or knowledge packs), and make recommendations based on comparisons of the user signatures to the knowledge signatures. The analysis can be performed by recommendations generator 366, for example, when a new knowledge pack is published, when a new user is added, and/or when the user profile of a user changes.

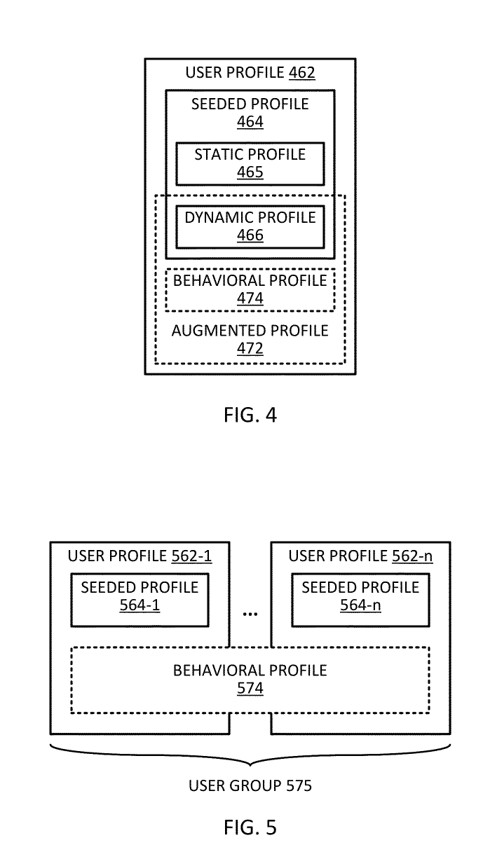

FIG. 4 illustrates a user profile 462 associated with a user of a knowledge automation system, according to some embodiments. User profile 462 can be stored, for example, in a user profile database. User profile 462 may include a seeded profile 464, and an augmented profile 472. Seeded profile 464 may include information about the user that is seeded or provided to the system when the user enrolls or registers in the knowledge automation system. For example, seeded profile 464 may include information such as the name of the user, the location and/or time zone of the user, role and/or job function of the user, work group the user is part of, experience of the user, expertise of the user, etc. Seeded profile 464 may include a static profile 465 that is generally static and does not change often for a user. For example, information such as name, location and/or time zone, and role and/or job function, etc. may be part of the static profile 465. Seeded profile 464 may also include a dynamic profile 466 that includes seeded information about a user that may change over time. For example, information such as work group, experience, and expertise, etc. can be part of dynamic profile 466, because the user's experience and expertise may grow over time, and the user can be placed on different teams over time.

Augmented profile 472 may include information about the user that the knowledge automation system modifies or adds to user profile 462. Augmented profile 472 may include information about the user that the knowledge automation system learns over time via monitoring of the user's activities and interactions with the system. Augmented profile 472 may include dynamic profile 466 that overlaps with seeded profile 464. For example, if the user has been consuming a large amount of knowledge about a particular topic, the knowledge automation system may add that topic to the user's seeded expertise. As another example, as the user completes one project and is placed on a different project team, the knowledge automation system may modify the seeded work group of the user to reflect this change.

Augmented profile 472 also includes behavioral profile 474 that represents the user's usage patterns in the knowledge automation system. For example, behavioral profile 474 may include information such as topics and/or publishers of knowledge packs that the user consumes, categories of knowledge packs that the user consumes, key terms that the user searches for, topics of knowledge packs that the user publishes, etc. Based on the user's activities and interactions with the system, the knowledge automation system may infer specific topics that the user may be interested in. In some embodiments, the user may be allowed to adjust the user's interest level of the topics that the knowledge automation system inferred, and this information can be included in behavioral profile 474.

In some embodiments, the knowledge automation system may group multiple users into a user group. A user group can be formed based on common attributes of the users. For example, users in the same work group can be formed into a user group, or users at the same location or time zone can be formed into a user group, etc. In some embodiments, a user group can be formed based on common behaviors of the users. For example, if a set of users often consumes knowledge packs on a particular topic, these users can be formed into a user group. As another example, if a set of users often publishes a particular category of knowledge packs, these users can be formed into a user group. It should be understood that a user can belong to more than one user group.

FIG. 5 illustrates user profiles of users belonging to a user group 575, according to some embodiments. User group 575 may include any number of users, and may include a user associated with user profile 562-1, and a user associated with user profile 562-n. User profiles 562-1 and 562-n may have respective seeded profiles 564-1 and 564-n. In some embodiments, because these users are part of the same user group 575, the knowledge automation system may augment user profiles 562-1 and 562-n with a group behavioral profile 574 across the entire user group based on the behaviors of members in the groups. For example, if knowledge automation system determines that a large number of members in user group 575 are interested in mobile device security, even though the user associated with user profile 562-1 may not have shown an interest in this topic, user profile 562-1 (as well as other user profiles of members in the group) may nevertheless be augmented to include mobile device security as a topic that the user may be interested in, because the user is part of user group 575. In this manner, the behaviors of members in a user group can be inferred to other members in the same user group. This allows the knowledge automation system to make knowledge recommendations to a user based on the not just the activities and interactions of that particular user alone, but also based on the activities and interactions of other users who are similar to that particular user.

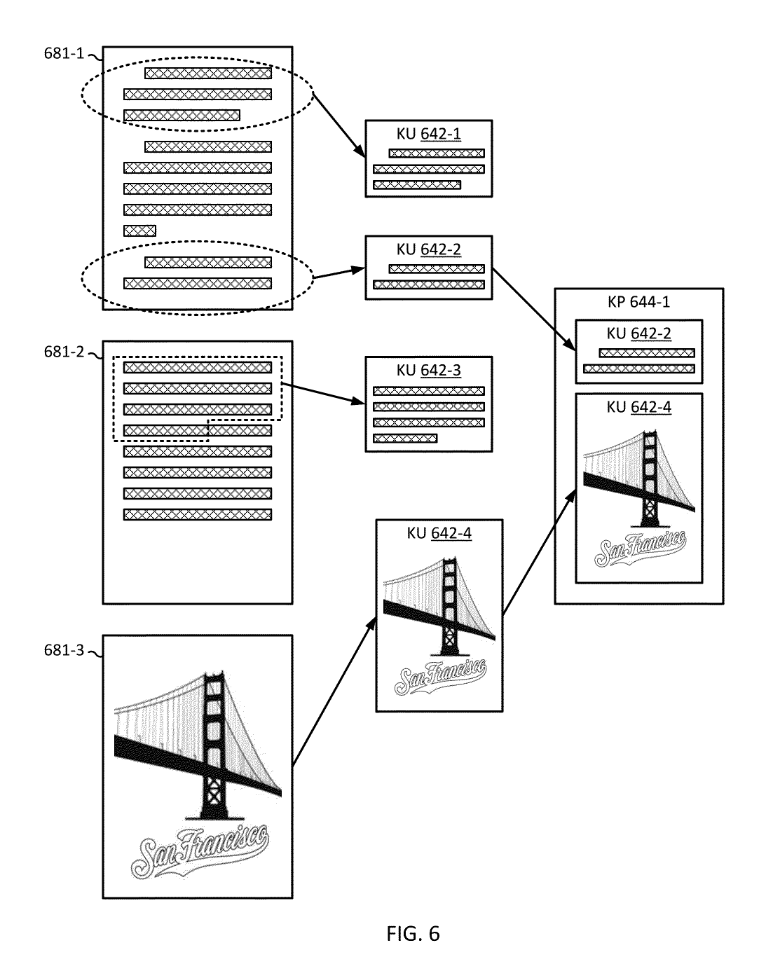

FIG. 6 illustrates an example formation of a knowledge pack from data content, according to some embodiments. In the example shown in FIG. 6, the data content discovered by the knowledge automation system may include a structured text file 681-1, an unstructured text file 681-2, and an image file 681-3.

Structured text file 681-1 can be parsed and analyzed based in part on the organization and structure of the document. For example, structured text file 681-1 may be organized into three paragraphs. The knowledge automation system may analyze structured text file 681-1, and determine that the first paragraph pertains to information about the state of California, the second paragraph discusses major cities on the west coast, and the third paragraph pertains to information about the city of San Francisco. This determination can be made, for example, based on a high frequency count of the key term “California” appearing in the first paragraph, various city names appearing in the second paragraph, and a high frequency count of the key term “San Francisco” appearing in the third paragraph. Based on this analysis, the knowledge automation system may segment structured text document 681-1 into individual paragraphs, and form a knowledge unit 642-1 directed to “California” from the first paragraph, and a knowledge unit 642-2 directed to “San Francisco” from the third paragraph.

Unstructured text file 681-2 may include a text blob without any apparent organization or structure in the document. The knowledge automation system may perform key term analysis on unstructured text file 681-2, and determine that the first portion of the document includes a high frequency count of the key term “California,” whereas the second portion of the document does not have any repeated key words or key phrases. Based on this analysis, the knowledge automation system may extract the first portion where the key term “California” appears repeatedly, and form a knowledge unit 642-3 directed to “California” from the first portion of unstructured text file 681-2.

Image file 681-3 may include a picture of the word “San Francisco.” The knowledge automation system may perform optical character recognition on image file 681-3, and extract the key term “San Francisco” from the picture. Based on this analysis, the knowledge automation system may form a knowledge unit 642-4 directed to “San Francisco” from image file 681-3.

Having generated knowledge units 642-1, 642-2, 642-3, and 642-4, the knowledge automation system may analyze the available knowledge units, and form knowledge packs by combining knowledge units directed to similar topics. For example, the knowledge automation system may form a knowledge pack 644-1 directed to the topic “San Francisco” by combining knowledge unit 642-2 and knowledge unit 642-4, which the knowledge automation system has tagged as being related to the topic “San Francisco.”

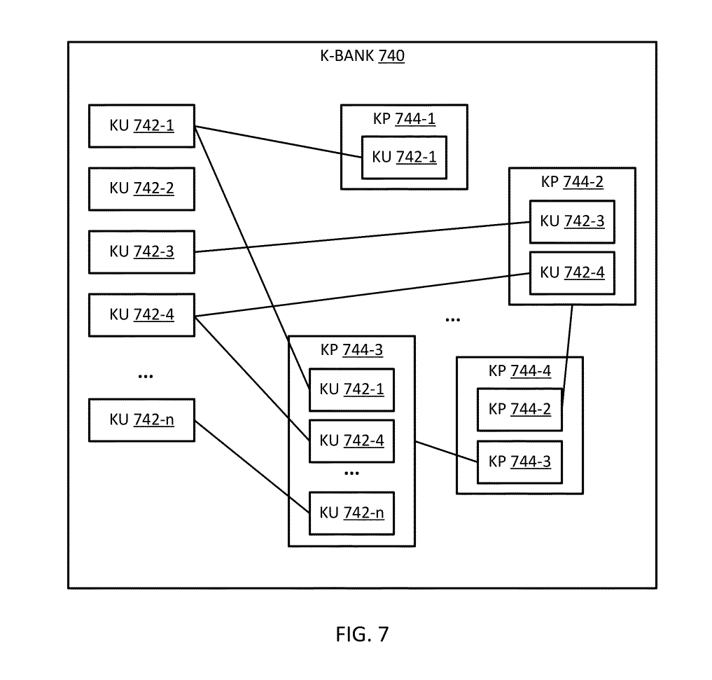

FIG. 7 illustrates a conceptual diagram of an example of the contents in a knowledge bank 740, according to some embodiments. Knowledge bank 740 may store the knowledge corpus of the knowledge automation system, and may include knowledge units 741-1 to 741-n. Knowledge units 741-1 to 741-n can be generated by the knowledge automation system from data content available in one or more content sources using the content discovery and ingestion techniques described herein. Based on the similarity mapping between knowledge units 741-1 to 741-n, or based on a input from knowledge publishers, knowledge packs 744-1 to 744-4 can be formed. For example, knowledge pack 744-1 can be generated from a single knowledge unit 742-1. Knowledge pack 744-2 can be generated by combining knowledge units 742-3 and 742-4. Knowledge pack 744-3 can be generated by combining knowledge units 742-1 and 742-4 to 742-n. Knowledge pack 744-4 can be generated by combining knowledge packs 744-2 and 744-3.

As this example illustrates, a single knowledge unit (e.g., knowledge unit 742-1) can be part of multiple knowledge packs (e.g., knowledge packs 744-1 and 744-3). A knowledge pack (e.g., knowledge pack 744-1) may include a single knowledge unit (e.g., knowledge unit 742-1). A knowledge pack (e.g., knowledge pack 744-2) may also include more than one knowledge unit (e.g., knowledge units 742-3 and 742-4). A knowledge pack (e.g., knowledge pack 744-4) may include other knowledge packs (e.g., knowledge packs 744-2 and 744-3). In some embodiments, a knowledge pack may also include a combination of one or more knowledge units and one or more knowledge packs.

### III. Knowledge to User Mapping

In some embodiments, the knowledge automation system can provide a knowledge mapping service to automatically provide knowledge recommendations to users by mapping users to relevant knowledge. The knowledge mapping service can be performed as new users and/or new knowledge elements are added to the system, and as the system learns knowledge interest patterns of the users based on user interactions with the system. The knowledge mappings can be dynamically adjusted, for example, by adding or removing knowledge recommendations to accommodate changes in user roles or user behavior. In this manner, relevant knowledge can be provided to the right users at the right time, without requiring ongoing manual matching or curation. The automatic knowledge mapping service can also reduce the time required to get relevant information to users (e.g., by eliminating the need for a user to search manually for the relevant information). Additionally, by targeting knowledge that is most relevant to the user, the automatic knowledge mapping service can avoid overloading users with too much information, which may lead to users missing relevant knowledge even when it has been provided to them.

In some embodiments, the knowledge mapping can be performed using knowledge signatures and user signatures. The knowledge automation system can generate a knowledge signature for each knowledge element (e.g., knowledge unit or knowledge pack) in the system. In some embodiments, the term vector associated with a knowledge element can be used as the knowledge signature. The knowledge automation system can also generate a user signature for each user of the system. In some embodiments, the user signature can be based on user profile information such behavioral profile information about the user (e.g., information relating to user activities and interactions on the system such as knowledge that the user has consumed, knowledge that the user has searched for, and/or knowledge that the user has published), and/or seeded profile information about the user (e.g., information provided when the user enrolls or registers for the system). Whenever a new knowledge pack is generated or published by a knowledge publisher, or whenever a knowledge unit is generated from new content added to the system, the knowledge automation system can automatically compare the knowledge signature of the new knowledge element to the user signatures of users of the system to determine matching users who may be interested in the new knowledge element. Furthermore, as users search, consume, and/or publish knowledge elements, the user signatures can be updated to reflect the knowledge interest patterns of the users, and the knowledge automation system can automatically compare the knowledge signature of the knowledge elements in the system to the updated user signatures to determine knowledge elements that may be of interest to the users.

In some embodiments, access control rules can be applied during knowledge mapping. For example, if a user is matched to a knowledge element, the system can determine whether the user belongs to a category or group of users that can have access to this knowledge element. If so, the knowledge element can be recommended to the user. However, if the user is restricted from consuming the knowledge element and access rights would be violated, then the knowledge element may not be recommended to the user.

In some embodiments, when a user is first added to the system, the user can be assigned a blank user signature. In some embodiments, seeded profile information (e.g., job function, work group, location, etc.) can be added to the user signature to generate an initial user signature. Additional information such as interests of the user as provided or seeded by the user can also be collect and be added as part of the initial user signature. As the user searches, views and consumes knowledge packs and/or knowledge units, and/or publishes knowledge elements to the system, key terms from the searches and/or key terms from the knowledge elements consumed or published can be extracted and added to the user signature. In some embodiments, if the same key term is associated with multiple knowledge packs or knowledge units consumed or published by the user, or the same key term is repeatedly searched, then the weight for that key term can be correspondingly increased.

A user can potentially search, consume, and/or publish many different knowledge elements overtime, which may result in lengthy user signatures. As such, in some embodiments, an optimization can be applied to the user signatures to maintain a predetermined number of top key terms (e.g., the top one hundred key terms), while discarding any remaining key terms. In some embodiments, the number of key terms in a user signature may vary based on the user's role, the user's employment history with the organization, or other user-specific metrics, etc.

The knowledge automation system may then apply a matching algorithm to the user signatures and knowledge signatures. For example, in some embodiments, a matching algorithm can be provided which increases a match score for each matching term appearing in both signatures, and one or more thresholds for match scores can be set to indicate whether a match between a knowledge consumer and the knowledge unit/pack has been found. In some embodiments, the match score thresholds may be adjusted to find fewer or more matches.

In some embodiments, the knowledge matching service can be enhanced through analysis of metadata associated with the knowledge elements (e.g., user comments, user ratings, etc.). For example, a knowledge element that is matched to a particular knowledge consumer may nevertheless be not recommended to the user if the user ratings for that knowledge element is low.

In some embodiments, a knowledge consumer may override the knowledge automation system and adjust the weight of a key term in the user signature. By adjusting the weight given to a key term, the knowledge consumer can adjust the interest level for that key term to refine and tailor the knowledge recommendations provided by the system. In some embodiments, user feedback can also be received regarding the relevance of recommendations provided through the automatic knowledge mapping. If a recommendation is relevant as indicated by the knowledge consumer, the knowledge matching algorithm can increase the weights for the key terms associated with the recommended knowledge element. If the knowledge consumer indicates that the recommended knowledge element is not relevant, the weights for those key terms can be reduced. This provides a feedback loop for refining future recommendations given by the system.

The knowledge recommendations provided by the knowledge mapping service can be provided to a user through a graphical user interface. For example, a list of knowledge recommendations can be displayed to the knowledge consumer, and can be arranged based on the freshness of the knowledge and the degree of match (e.g., newer knowledge elements and knowledge elements with higher degree of match can be displayed first).

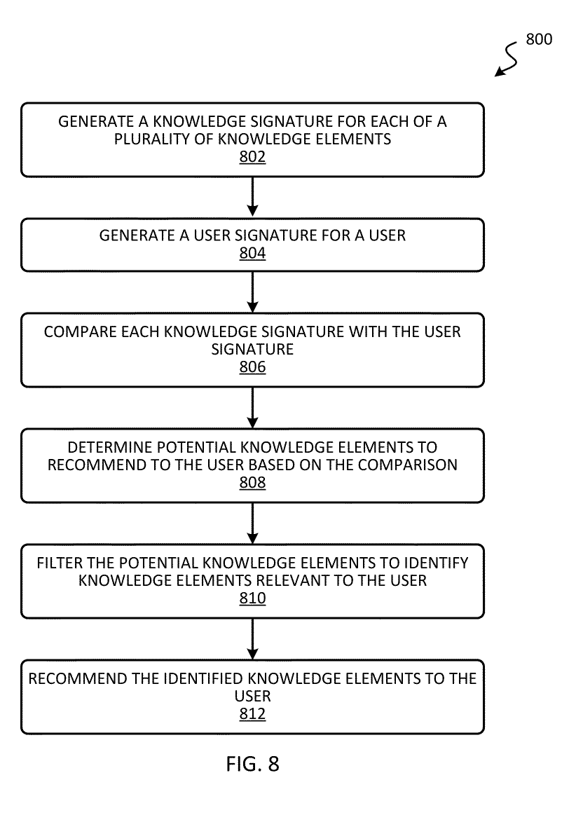

FIG. 8 illustrates a flow diagram of a knowledge mapping process 800 that can be performed by a knowledge automation system, according to some embodiments. Process 800 may begin at block 802 by generating a knowledge signature for each knowledge elements (e.g., each knowledge unit and/or knowledge pack) available to the knowledge automation system. In some embodiments, a term vector associated with the knowledge element can be used as the knowledge signature.

At block 804, a user signature is generated for a user (e.g., a knowledge consumer and/or knowledge publisher) of the knowledge automation system. The user signature can be generated based on the user profile of the user, and may include behavioral user profile information such as key terms of knowledge elements that the user has searched for, consumed, and/or published. In some embodiments, the key terms associated with a user profile may also include publishers of the knowledge elements that the user frequently consumes. The key terms associated with a user profile can also be referred to as the user's interest patterns as the key terms provide an indication of subjects and/or publishers that the user may be interested in. The user signature may also include seeded information such as the user's job function and role. The user signature may also include augmented profile information relating to activities of other users in the user group that the user belongs to (e.g., key terms of knowledge elements searched, consumed, and/or published by other users in the same user group).

At block 806, the knowledge signature of each knowledge element is compared with the user signature. The comparison can be based on a match score representing a count of common key terms appearing in both signatures. In some embodiments, certain key terms can be given more weight than other key terms (e.g., based on user adjustment of the interest level for the key term). At block 808, potential knowledge elements to recommend to the user are determined based on the comparison performed at block 806. For example, a knowledge element having a match score above a predetermined threshold score can be determined as a potential knowledge element to recommend to the user. In some embodiments, the threshold score can be adjusted to adjust the number of relevant knowledge elements found.

As an example, each un-weighted matching key term can be given a score of 10 points. If a user increased the interest level of a key term to very interested, the weight of that key term can be increased to 20 points; and if a user decreased the interest level of a key term to not interested, the weight of that key term can be reduced to 0 points. Suppose a user signature includes key terms A, B, C, D, and E, and the user has indicated that the user is very interested in key term E, and not interested in key term B. The weighted scores for matching key terms for this particular user can then be A=10, B=0, C=10, D=10, and E=20. Suppose a knowledge element signature includes key terms B, C, E, F, and G. The matching score for this particular user and this knowledge element can then be 30 (0 points for matching key term B, 10 points for matching key term C, and 20 points for matching key term E). A threshold matching score such as 25 points can be set such that if a knowledge element has a matching score at or above this threshold, the knowledge element is recommended to the user. In the scenario described above, since the knowledge element has a matching score of 30, this knowledge element would be recommended to the user. If a threshold score of 25 points yields too many matching knowledge elements, the threshold score can be increased to reduce the number of marching knowledge elements. If a threshold score of 25 points yield too few matching knowledge elements, the threshold score can be decreased to increase the number of matching knowledge elements. It should be understood that the scenario described above is just an example, and that in various embodiments, different points, weights, and thresholds can be used.

At block 810, the potential knowledge elements are filtered to identify knowledge elements that are most relevant or useful to the user. One or more filtering criteria can be used. For example, stale knowledge elements that are older than a certain age can be filtered out, and/or knowledge elements with user ratings or viewership less than a threshold amount can be filtered out. At block 812, process 800 recommends the identified knowledge elements that are most relevant t or useful to the user. For example, the knowledge automation system may display a list of the identified knowledge elements on a recommendations page of a graphical user interface for the user.

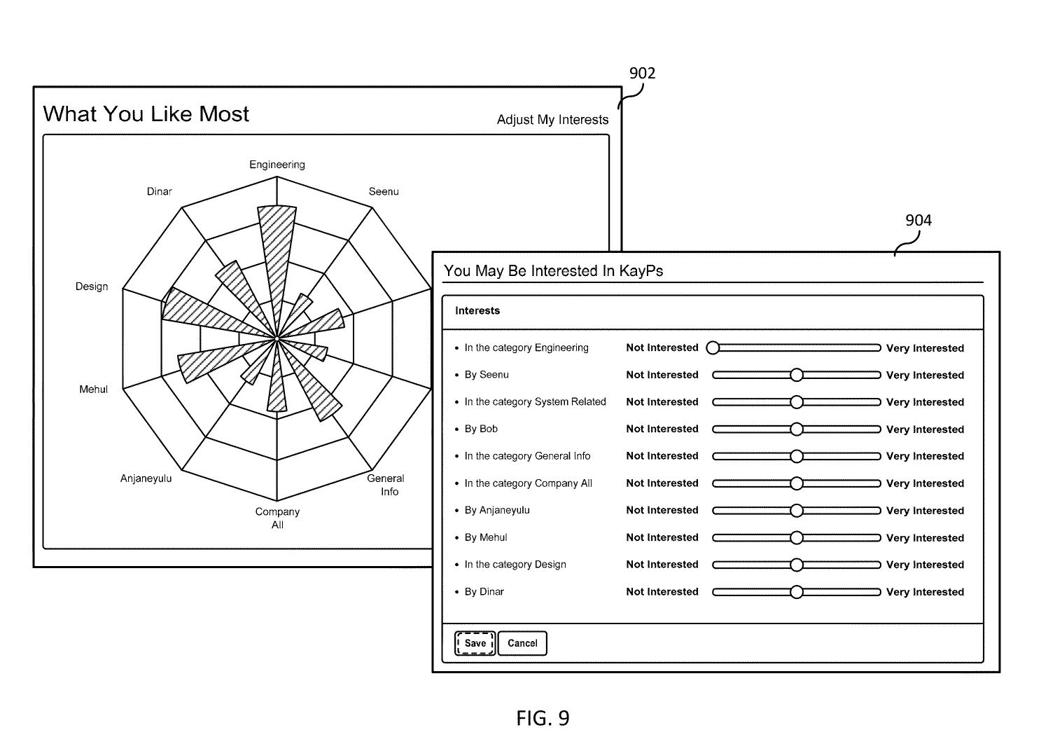

FIG. 9 illustrates a diagram of a user's interest patterns in identified content 902 and a graphical user interface for adjusting the interest levels 904, according to some embodiments. As shown in FIG. 9, user interests can be modeled based on the user's activity. For example, the knowledge automation system may determine a user's interest based on topics, categories, and/or key terms associated with knowledge elements that the user has searched, consumed, and/or published, as well as authors or publishers that are regularly followed by the user. For example, if the user accesses and views knowledge packs published by a certain knowledge publisher, the user model will reflect an interest in that publisher. Similarly, interests may be modeled based on categories of content. For example, if the user frequently accesses and consumes knowledge packs in the engineering category, then the user model will reflect an interest in engineering material. Knowledge elements consumed by a user may also be analyzed, e.g., based on key terms, to identify additional dimensions of interest for a user.

In addition to automatically identifying a user's interests based on their user profile, a graphical user interface 904 may be provided to the user to manually adjust their interest levels for interests of the user identified by the knowledge automation system. The sliders depicted in FIG. 9 allows a user may manually adjust their level of interest. In some embodiments, a dial or other user interface element such as an text box that can allow a user to enter a numeric interest level value can be used. The adjusted level of interest can be taken into account to improve the knowledge mapping performed by the knowledge automation system. For example, if the user adjusts the interest level of an interest to “Not Interested,” the weight of that key term used in the matching algorithm can be reduced or the key term be eliminated. If the user adjusts the interest level of an interest to “Very Interested,” the weight of that key term used in the matching algorithm can be increased.

### III. Activity Stream

In some embodiments, the knowledge automation system can provide to a user an interest based activity stream of peer activities performed on knowledge elements of interest to the user. This may include activities such as comments on knowledge elements left by other users, updates to knowledge elements published by other users, and/or ratings of knowledge elements from other users. This enables a user to view activities, updates, and other relevant information for the knowledge areas of interest to the user, without requiring the user to also view irrelevant information. User interests can be determined based on interactions between the user and the system (e.g., implicit and explicit actions taken by the user such as search queries submission, knowledge element consumption, and knowledge element publication). In this manner, the user is not inundated with irrelevant activity information, but is instead intelligently presented with activities that are of relevance to the user.

Some systems may allow a user to subscribe to a particular feed, and comments or updates posted to the feed can be provided to the user. However, in such systems, a user can be inundated with irrelevant information because any comments or updates posted to the feed, regardless of its relevance, will be presented to the user. For example, a user with the role “salesperson” may be associated with a variety of interests, such as they technology area for which they sell, knowledge published by developers in related technology groups, etc. This can lead to a variety of activity updates being available to the user at any given time. Without sorting the activity updates intelligently, based on explicit or implicit user interactions, the user may become overloaded and ignore further updates. Such systems do not provide a mechanism to adaptively and intelligently learn what the user is interested in, and do not provide a mechanism for the user to provide feedback to the system about what the user's interests are.

In contrast to such systems, the knowledge automation system according to some embodiments can dynamically learn what the user may be interested in, present to the user interest patterns identified by the system to allow a user to adjust the interest level of the identified areas or topics of interest, and dynamically change what activates are presented to the user based on the learned interest patterns and user feedback. For example, a knowledge service can monitor the user's activity and tailor the activity updates. A user's interest patterns can be determined both passively (e.g., based on user interactions with the system) and actively (e.g., based on feedback received from the user, administrator or other entity), and be stored in the user profile of the user. Content consumed by a particular user can be analyzed to identify commonalities (such as, authorship, subject matter, ratings, etc.) between the consumed content. Interest patterns identifying areas of interest to the user can be stored in a user profile, and the activities presented to the user can be tailored based on the interest patterns.

For example, if the user has recently completely viewed a knowledge element (e.g., a knowledge unit and/or knowledge pack), comments from other users on that knowledge element can be shown in the user's activity stream over the comments on articles the user has not viewed. Furthermore, comments on articles the user has published can have priority over others in the user's activity stream. Similarly, based on the user's interest patterns in the user profile, knowledge published in categories of the user's interests can be shown in the user's activity stream over other articles. This takes the otherwise overwhelming number of activity updates and produces a consumable amount of activity notifications for each user. In some embodiments, a graphical representation of a user interest patterns can also be displayed on a graphical user interface such as user interface 904 shown in FIG. 9 to allow a user to manual modified the interest levels of topics of interests to the user, such that the user can override or adjust what the system has perceived as being of interest to the user.

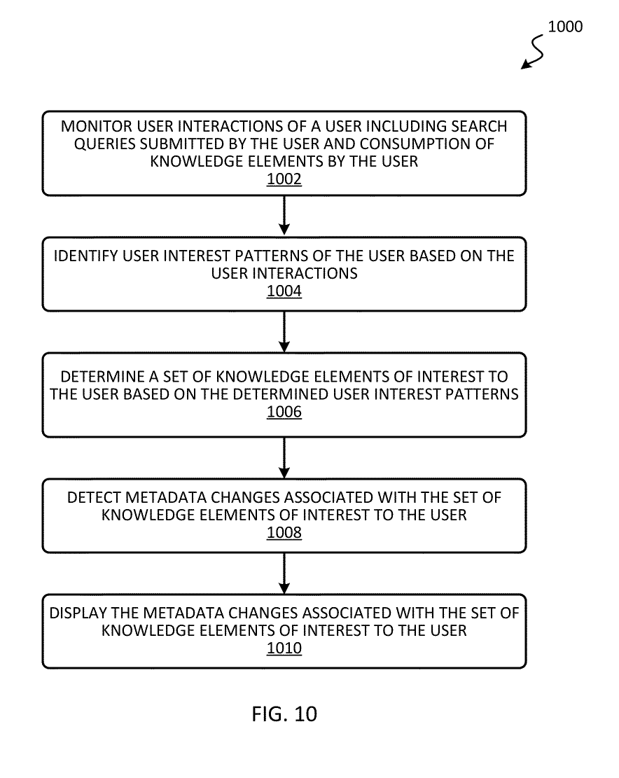

FIG. 10 illustrates a flow diagram of an activity streaming process 1000 that can be performed by a knowledge automation system, according to some embodiments. Process 1000 may begin at block 1002 by monitoring a user's interactions with the knowledge automation system. The user interactions may include search queries submitted by the user, consumption of knowledge elements by the user, and/or publication of knowledge elements by the user, etc. For example, when a user submits search queries, the search queries can be tracked and key term(s) appearing in the search queried can be identified. Similarly, when a user consumes or publishes knowledge elements, key term(s) associated with the knowledge elements can be identified and tracked. In some embodiments, when a user consumes knowledge elements, the publishers of the knowledge elements consumed by the user can also be identified and tracked.

At block 1004, user interest patterns of the user can be identified by the knowledge automation system based on the user interactions with the system. Key terms associated with knowledge elements that the user frequently searches for, consumes, and/or publishes can be determined and identified as knowledge topics that are of interest to the user. The key terms can be added to the user's profile as the user interest patterns. For example, a top threshold number (e.g., top twenty) of the most frequently searched, consumed, and/or published key terms can be identified as topics of interest to the user, and be added to the user's profile as the user interest patterns. In some embodiments, key terms that the user has searched, consumed, and/or published above a threshold number of times can be identified and be added to the user's profile as the user interest patterns. For example, if a user has searched, consumed, and/or published knowledge elements relating to a particular key term more than ten times, that key term can be added to the user's profile as the user interest patterns. In some embodiments, publishers of the knowledge elements that the user consumes can also be identified and added to the user's profile as the user interest patterns. For example, if a publisher publishes more than a threshold number of knowledge elements consumed by the user (e.g., a publisher who has published more than five knowledge elements that the user has consumed), that publisher can added to the user's profile as the user interest patterns.

In some embodiments, in addition to the user's own interactions with the system, user interactions (e.g., searches, consumption, publication, etc.) of other users of a user group that the user belongs to can also be monitored, and the user interest patterns of the user can be identified further based on the user interactions of other users of the user group. For example, if the user belongs to a marketing team responsible for a particular product, even though the user has not consumed a new version of that product's datasheet, if other users in the marketing team has consume the datasheet, it can be inferred that the user would also be interested in the datasheet. As such, key terms identified from knowledge elements that other users belonging to the same user group interacted with can be combined with key terms identified from knowledge elements that user interacted with to derive the user interest patterns.

At block 1006, a set of knowledge elements of interest to the user are determined based on the user interest patterns. In some embodiments, the set of knowledge elements of interest to the user can be determined using a match score technique similar to those described above with reference to the knowledge mapping service. In other words, a user signature that includes key terms and publishers can be derived based on the user interest patterns of the user, and be compared with knowledge signatures of knowledge elements to identify a set of knowledge elements that are of interest to the user. In some embodiments, common key terms between the user signature and the knowledge signature can be given more weight than common publishers when determining the match score, and knowledge elements having a match score above a predetermined threshold score can be determined as knowledge elements that are of interest to the user. In some embodiments, the threshold score can be adjusted to adjust the number of knowledge elements found to be of interest to the user.

In some embodiments, a knowledge element that the user has consumed and/or published may have a match score below the predetermined threshold score. In such scenarios, even though the knowledge element may have a match score below the predetermined threshold score, the knowledge element may nevertheless be included in the set of knowledge elements of interest to the user, because the user has explicitly interacted with the knowledge element. In some embodiments, the set of knowledge elements of interest to the user may also include at least one knowledge element that the user did not consume or publish. This can occur, for example, if other users belonging to the same user group have consumed that knowledge element, or if the match score technique determines a knowledge element that the user did not consume or publish may nevertheless be of interest to the user based on common key terms or publisher between the knowledge element and the user interest patterns.

At block 1008, process 1000 may detect metadata changes associated with the set of knowledge elements of interest to the user. In some embodiments, the metadata changes may include one or more of a new user comment, a new user rating, and content update associated with a knowledge element in set of knowledge elements of interest to the user. For example, when a user posts a new comment about a knowledge element, information associated with comment (e.g., the comment itself, author of the comment, and time comment was posted, etc.) can be added to the metadata of the knowledge element. As another example, when a user rates a knowledge element, information associated with rating (e.g., the rating itself, user who provided the rating, and time of rating, etc.) can be added to the metadata of the knowledge element. As a further example, when a user provides content update to a knowledge element, information associated with update (e.g., the updated content, publisher who updated the content, and time of update, etc.) can be added to the metadata of the knowledge element. These changes to the metadata can be detected and be presented to a user to inform the user of activities relating to knowledge elements that are of interest to the user.

At block 1010, the metadata changes associated with the set of knowledge elements of interest to the user can be displayed by the system on a graphical user interface to inform the user of activities relating to the knowledge elements that are of interest to the user. In some embodiments, metadata changes provided by the user need not be displayed because the user can be assumed to know of these changes already. Thus, in some embodiments, only metadata changes provided by other users are displayed. In some embodiments, the set of knowledge elements of interest to the user can be ranked and sorted based on relevance to the user, and the metadata changes can be displayed according to the order of the ranked knowledge elements (e.g., metadata changes to more relevant knowledge elements are displayed before metadata changes to less relevant knowledge elements). The ranking and sorting can be performed based on the match score. Furthermore, knowledge elements the user has consumed or published can be ranked higher than knowledge elements that the user has not consumed or published. In some embodiments, the metadata changes can be displayed in chronological order, or can be displayed based on both the chronological order and ranking of the knowledge element. In some embodiments, the metadata changes for a particular knowledge element can be grouped together. In some embodiments, the metadata changes for multiple knowledge elements can be displayed together.

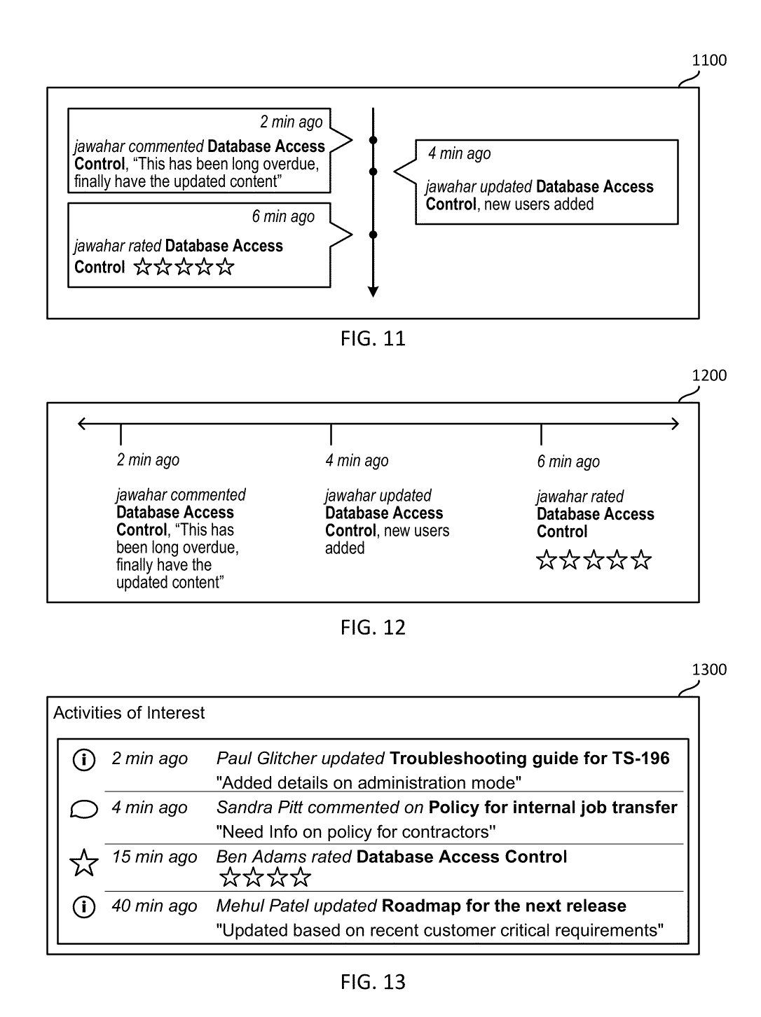

FIGS. 11-13 illustrate various graphical user interfaces for displaying the metadata changes associated with the set of knowledge elements of interest to the user, according to some embodiments. Referring to FIG. 11, graphical user interface 1100 may group metadata changes for a particular knowledge element together, and display them together in a region of graphical user interface 1110. Each metadata change being displayed can include time information indicating when the metadata change occurred (e.g., can be displayed as an elapsed time such as “2 min. ago,” or as actual time such as 10:05 pm, etc.), an identifier of the knowledge element, the user who provided the metadata change, and the actual metadata change itself (e.g., the comment left by a user, the rating provided by a user such as the number of stars or rating score, or a description of or the actual content updated to the knowledge element). In some embodiments, the time information can be displayed on a separate line, and the identifier of the knowledge element, the user who provided the metadata change, and the actual metadata change itself can be displayed using different formats to different each element from the others. For example, the user who provided the metadata change can be displayed in italics, the identifier of the knowledge element of be displayed in bold, and the metadata change can be displayed in normal font. In some embodiments, the different elements can also be displayed in different colors to differentiate form one another. The metadata changes can be displayed in chronological order together with a timeline to indicate the order in which the metadata changes were made. In graphical user interface 1100, a vertical timeline is displayed, and the metadata changes can be displayed on both sides of the vertical timeline. In some embodiments, the metadata changes can be displayed on only one side of the vertical timeline.

FIG. 12 illustrates another graphical user interface 1200 for displaying metadata changes, according to some embodiments. Graphical user interface 1200 is a variation of graphical user interface 1100. In the example shown, the information relating to the metadata changes being displaying in graphical user interface 1200 are the same as those in graphical user interface 1100. Instead of displaying a vertical timeline, graphical user interface 1200 uses a horizontal timeline, and the metadata changes can be displayed in chronological order below the horizontal timeline as shown. In some embodiments, the metadata changes can be displayed above the horizontal timeline, or be displayed both above and below the horizontal timeline.

FIG. 13 illustrates another graphical user interface 1300 for displaying metadata changes, according to some embodiments. Graphical user interface 1300 displays metadata changes for multiple knowledge elements together. The metadata changes can be displayed in chronological order as shown, and may display similar information as those described above. In some embodiments, an icon representing the type of metadata change can also be displayed to allow a user to easily identify what kind of metadata change has been added to the system. For example, an information icon can be displayed to represent a metadata change relating to update of content. A comment bubble can be displayed to represent a metadata change relating to a comment. A star can be displayed to represent a metadata change relating to a user rating of a knowledge element.

In some embodiments, because the number of metadata changes that can be displayed may be limited by the available area of the graphical user interface, a scroll bar can be included in the graphical user interface (e.g., any of graphical user interfaces 1100, 1200, or 1300) to allow a user to scroll through the activity stream of metadata changes. In some embodiments, as new activities or metadata changes are detected and added to the graphical user interface, older or stale metadata changes can be removed from the graphical user interface. In some embodiments, metadata changes that are older than a predetermined age (e.g., older than a month) can be automatically removed from the graphical user interface.

According to some embodiments, a user's interest may change over time. As such, knowledge elements that may once be of interest to the user may no longer be of interest to the user at a later time. This may occur, for example, if a user has learned enough about a particular topic, or if the user changes role. Thus, in some embodiments, as the user interacts with the knowledge automation system more, the user interest patterns determined by the knowledge automation system can be adjusted to reflect a more accurate view of the user's interests.

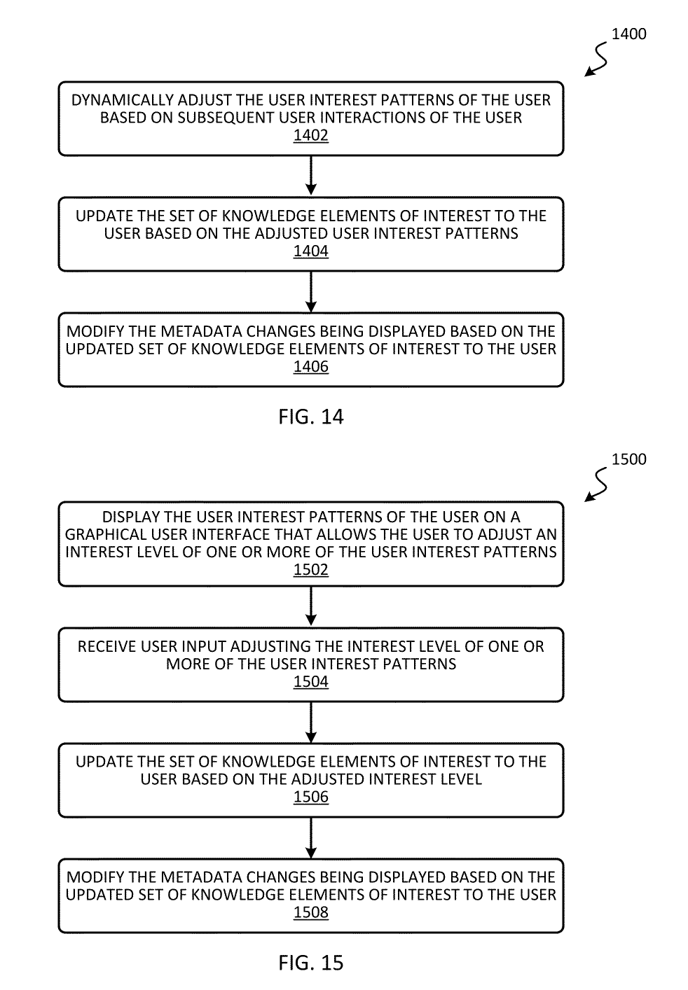

FIG. 14 illustrates a flow diagram of a process 1400 that can be performed by a knowledge automation system for adjusting the user interest patterns based on user interactions, according to some embodiments. In some embodiments, process 1400 can be continuously performed once an initial set of knowledge elements of interest to the user has been determined according to process 1300. In some embodiments, process 1400 can be performed at periodic intervals, or execution of process 1400 can be triggered by events such as when the user logs onto the system, when a subsequent user interaction is detected, or after a predetermined number of subsequent user interactions have occurred. Process 1400 may begin at block 1402 by dynamically adjusting the user interest patterns of the user based on subsequent user interactions of the user. The subsequent user interactions may occur, for example, after process 1300 has already been performed. For example, if the user subsequently searches for knowledge elements relating to a new topic, the user interest patterns can be adjusted to reflect this new interest.

At block 1404, the set of knowledge elements of interest to the user is updated based on the adjusted user interest patterns. In some embodiments, the match score used for identify knowledge elements of interest to the user can take into account the recency of the user interactions. For example, key terms or publishers associated with more recent user interactions can be given more weight when determining the match score, whereas key terms or publishers associated with older user interactions can be given less weight. Thus, in this manner, the set of knowledge elements determined to be of interest to the user can be continuously updated to reflect the most current interests of the user.

At block 1406, the metadata changes being displayed on a graphical user interface can be modified based on the updated set of knowledge elements of interest to the user. For example, if a knowledge element is no longer of interest to a user based on the updated user interest patterns, metadata changes associated with that knowledge element can be removed from the graphical user interface (e.g., graphical user interfaces 1100, 1200, or 1300). If a new knowledge element is added to the set of knowledge elements of interest to the user based on the updated user interest patterns, metadata changes associated with that knowledge element can added to the display of the graphical user interface (e.g., graphical user interfaces 1100, 1200, or 1300).

In some embodiments, even though the knowledge automation system can continuously and adaptively learn what the user's interests are, there can be instances where the user interest patterns identified by the system may differ from what the user's actual interest are. To allow a user to provide feedback to the system on the actual interests of the user, a graphical user interface similar to that shown in FIG. 9 can be provided to a user to allow a user to manually adjust the level of interest for each key term or publisher identified by the system. In some embodiments, a user may also be allowed to manually add a topic or publisher of interest.

FIG. 15 illustrates a flow diagram of a process 1500 that can be performed by a knowledge automation system for adjusting the user interest patterns based on user feedback, according to some embodiments. Process 1500 may begin at block 1502 by displaying the user interest patterns of the user on a graphical user interface that allows the user to adjust an interest level of one or more of the user interest patterns. An example can be graphical user interface 904 shown in FIG. 9.

At block 1504, user input adjusting the interest level of one or more of the user interest patterns is received. For example, a user may decrease the interest level of a key term or publisher to “Not Interested” or increase the interest level to “Very Interested.” In some embodiments, instead of using descriptive terms to indicate the interest level, numeric values representing the interest level can be used. For example, a user can set a assign higher numeric value to a key term or publisher to increase the interest level, or assign a lower numeric value to the key term or publisher to decrease the interest level.

At block 1506, the set of knowledge elements of interest to the user can be updated based on the adjusted interest level to one or more of the user interest patterns. For example, the match score used for identify knowledge elements of interest to the user can take into account the interest level as indicated by the user. In some embodiments, key terms or publishers whose interest level has been increased by the user can be given more weight when determining the match score, whereas key terms or publishers whose interest level has been decreased by the user can be given less weight. Thus, in this manner, the set of knowledge elements determined to be of interest to the user can be updated to reflect the user's feedback. In some embodiments, the weighting applied based on the adjusted interest levels can be combined with the weighting applied based on the recency of the key terms and publishers describe above to derive the match score.

At block 1508, the metadata changes being displayed on a graphical user interface can be modified based on the updated set of knowledge elements of interest to the user. For example, if a knowledge element is no longer of interest to a user based on the updated user interest patterns, metadata changes associated with that knowledge element can be removed from the graphical user interface (e.g., graphical user interfaces 1100, 1200, or 1300). If a new knowledge element is added to the set of knowledge elements of interest to the user based on the updated user interest patterns, metadata changes associated with that knowledge element can added to the display of the graphical user interface (e.g., graphical user interfaces 1100, 1200, or 1300).

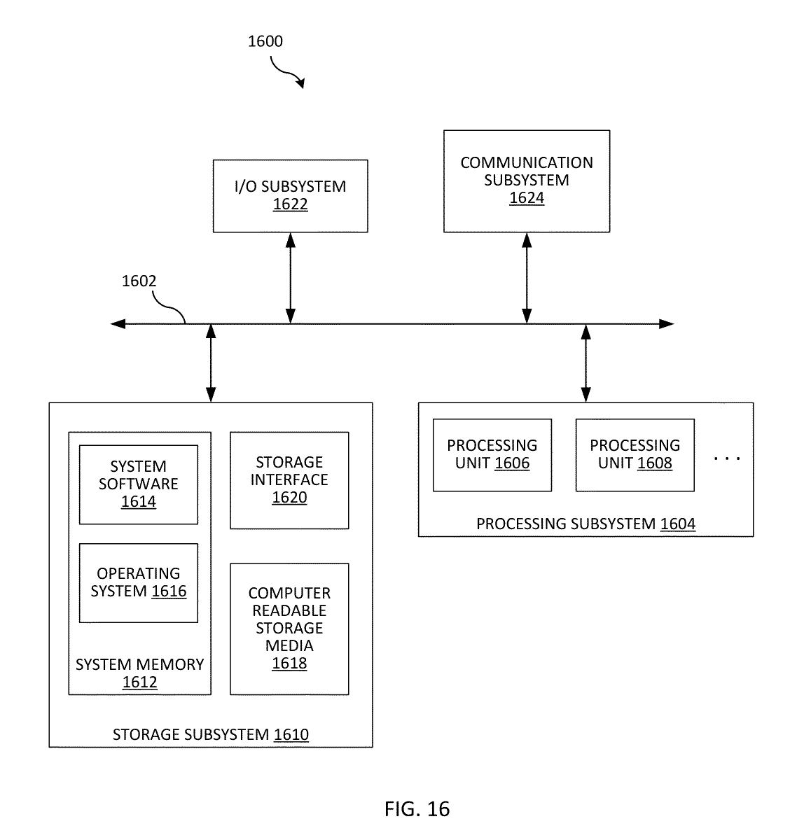

FIG. 16 depicts a block diagram of a computing system 1600, in accordance with some embodiments. Computing system 1600 can include a communications bus 1602 that connections one or more subsystems, including a processing subsystem 1604, storage subsystem 1610, I/O subsystem 1622, and communication subsystem 1624.

In some embodiments, processing subsystem 1608 can include one or more processing units 1606, 1608. Processing units 1606, 1608 can include one or more of a general purpose or specialized microprocessor, FPGA, DSP, or other processor. In some embodiments, processing unit 1606, 1608 can be a single core or multicore processor.

In some embodiments, storage subsystem can include system memory 1612 which can include various forms of non-transitory computer readable storage media, including volatile (e.g., RAM, DRAM, cache memory, etc.) and non-volatile (flash memory, ROM, EEPROM, etc.) memory. Memory may be physical or virtual. System memory 1612 can include system software 1614 (e.g., BIOS, firmware, various software applications, etc.) and operating system data 1616. In some embodiments, storage subsystem 1610 can include non-transitory computer readable storage media 1618 (e.g., hard disk drives, floppy disks, optical media, magnetic media, and other media). A storage interface 1620 can allow other subsystems within computing system 1600 and other computing systems to store and/or access data from storage subsystem 1610.

In some embodiments, I/O subsystem 1622 can interface with various input/output devices, including displays (such as monitors, televisions, and other devices operable to display data), keyboards, mice, voice recognition devices, biometric devices, printers, plotters, and other input/output devices. I/O subsystem can include a variety of interfaces for communicating with I/O devices, including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports).

In some embodiments, communication subsystem 1624 can include various communication interfaces including wireless connections (e.g., Wi-Fi, Bluetooth, Zigbee, and other wireless communication technologies) and physical connections (e.g., USB, SCSI, VGA, SVGA, HDMI, DVI, serial, parallel, and other physical ports). The communication interfaces can enable computing system 1600 to communicate with other computing systems and devices over local area networks wide area networks, ad hoc networks, mesh networks, mobile data networks, the internet, and other communication networks.

In certain embodiments, the various processing performed by a knowledge modeling system as described above may be provided as a service under the Software as a Service (SaaS) model. According this model, the one or more services may be provided by a service provider system in response to service requests received by the service provider system from one or more user or client devices (service requestor devices). A service provider system can provide services to multiple service requestors who may be communicatively coupled with the service provider system via a communication network, such as the Internet.

In a SaaS model, the IT infrastructure needed for providing the services, including the hardware and software involved for providing the services and the associated updates/upgrades, is all provided and managed by the service provider system. As a result, a service requester does not have to worry about procuring or managing IT resources needed for provisioning of the services. This significantly increases the service requestor's access to these services in an expedient manner at a much lower cost point.

In a SaaS model, services are generally provided based upon a subscription model. In a subscription model, a user can subscribe to one or more services provided by the service provider system. The subscriber can then request and receive services provided by the service provider system under the subscription. Payments by the subscriber to providers of the service provider system are generally done based upon the amount or level of services used by the subscriber.

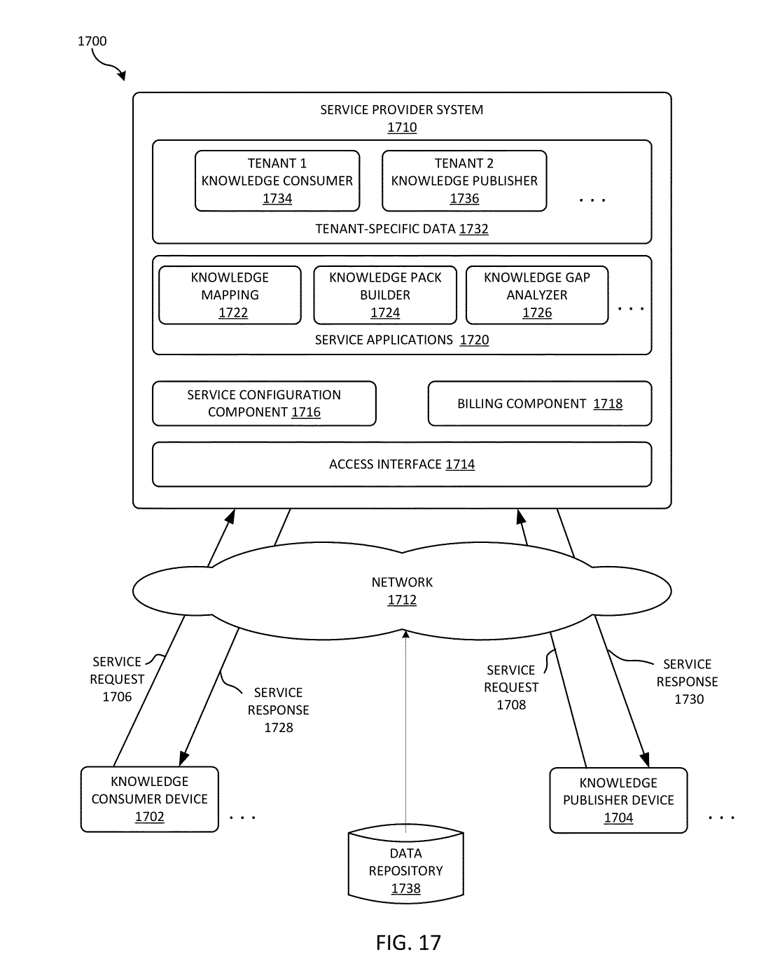

FIG. 17 depicts a simplified block diagram of a service provider system 1700, in accordance with some embodiments. In the embodiment depicted in FIG. 17, service requestor devices 1704 and 1704 (e.g., knowledge consumer device and/or knowledge publisher device) are communicatively coupled with service provider system 1710 via communication network 1712. In some embodiments, a service requestor device can send a service request to service provider system 1710 and, in response, receive a service provided by service provider system 1710. For example, service requestor device 1702 may send a request 1706 to service provider system 1710 requesting a service from potentially multiple services provided by service provider system 1710. In response, service provider system 1710 may send a response 1728 to service requestor device 1702 providing the requested service. Likewise, service requestor device 1704 may communicate a service request 1708 to service provider system 1710 and receive a response 1730 from service provider system 1710 providing the user of service requestor device 1704 access to the service. In some embodiments, SaaS services can be accessed by service requestor devices 1702, 1704 through a thin client or browser application executing on the service requestor devices. Service requests and responses 1728, 1730 can include HTTP/HTTPS responses that cause the thin client or browser application to render a user interface corresponding to the requested SaaS application. While two service requestor devices are shown in FIG. 17, this is not intended to be restrictive. In other embodiments, more or less than two service requestor devices can request services from service provider system 1710.

Network 1712 can include one or more networks or any mechanism that enables communications between service provider system 1710 and service requestor devices 1702, 1704. Examples of network 1712 include without restriction a local area network, a wide area network, a mobile data network, the Internet, or other network or combinations thereof. Wired or wireless communication links may be used to facilitate communications between the service requestor devices and service provider system 1710.

In the embodiment depicted in FIG. 17, service provider system 1710 includes an access interface 1714, a service configuration component 1716, a billing component 1718, various service applications 1720, and tenant-specific data 1732. In some embodiments, access interface component 1714 enables service requestor devices to request one or more services from service provider system 1710. For example, access interface component 1714 may comprise a set of webpages that a user of a service requestor device can access and use to request one or more services provided by service provider system 1710.

In some embodiments, service manager component 1716 is configured to manage provision of services to one or more service requesters. Service manager component 1716 may be configured to receive service requests received by service provider system 1710 via access interface 1714, manage resources for providing the services, and deliver the services to the requesting requesters. Service manager component 1716 may also be configured to receive requests to establish new service subscriptions with service requestors, terminate service subscriptions with service requestors, and/or update existing service subscriptions. For example, a service requestor device can request to change a subscription to one or more service applications 1722-1726, change the application or applications to which a user is subscribed, etc.).

Service provider system 1710 may use a subscription model for providing services to service requestors according to which a subscriber pays providers of the service provider system based upon the amount or level of services used by the subscriber. In some embodiments, billing component 1718 is responsible for managing the financial aspects related to the subscriptions. For example, billing component 1710, in association with other components of service provider system 1710, may be configured to determine amounts owed by subscribers, send billing statements to subscribers, process payments from subscribers, and the like.

In some embodiments, service applications 1720 can include various applications that provide various SaaS services. For example, one more applications 1720 can provide the various functionalities described above and provided by a knowledge modeling system.

In some embodiments, tenant-specific data 1732 comprises data for various subscribers or customers (tenants) of service provider system 1710. Data for one tenant is typically isolated from data for another tenant. For example, tenant 1's data 1734 is isolated from tenant 2's data 1736. The data for a tenant may include without restriction subscription data for the tenant, data used as input for various services subscribed to by the tenant, data generated by service provider system 1710 for the tenant, customizations made for or by the tenant, configuration information for the tenant, and the like. Customizations made by one tenant can be isolated from the customizations made by another tenant. The tenant data may be stored service provider system 1710 (e.g., 1734, 1736) or may be in one or more data repositories 1738 accessible to service provider system 1710.

It should be understood that the methods and processes described herein are exemplary in nature, and that the methods and processes in accordance with some embodiments may perform one or more of the steps in a different order than those described herein, include one or more additional steps not specially described, omit one or more steps, combine one or more steps into a single step, split up one or more steps into multiple steps, and/or any combination thereof.

It should also be understood that the components (e.g., functional blocks, modules, units, or other elements, etc.) of the devices, apparatuses, and systems described herein are exemplary in nature, and that the components in accordance with some embodiments may include one or more additional elements not specially described, omit one or more elements, combine one or more elements into a single element, split up one or more elements into multiple elements, and/or any combination thereof.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps. Various features and aspects of the above-described embodiments may be used individually or jointly.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims. For example, one or more features from any embodiment may be combined with one or more features of any other embodiment without departing from the scope of the invention.

What is claimed is:

1. A method comprising:
monitoring, by a data processing system, user interactions of a user with the data processing system, the user interactions including search queries submitted by the user and consumption of knowledge elements by the user;
identifying, by the data processing system based on the user interactions, user interest patterns of the user;
determining, by the data processing system, a set of knowledge elements of interest to the user based on the user interest patterns;
detecting, by the data processing system, metadata changes associated with the set of knowledge elements of interest to the user; and
displaying, by the data processing system, the metadata changes associated with the set of knowledge elements of interest to the user.

2. The method of claim 1, wherein the set of knowledge elements of interest to the user identified by the data processing system includes at least one knowledge element that the user did not consumed.

3. The method of claim 1, further comprising:
dynamically adjusting the user interest patterns of the user based on subsequent user interactions of the user;
updating the set of knowledge elements of interest to the user based on the adjusted user interest patterns; and
modifying the metadata changes being displayed based on the updated set of knowledge elements of interest to the user.

4. The method of claim 1, further comprising:
monitoring, by the data processing system, user interactions of other users of a user group that the user belongs to,
wherein the user interest patterns of the user are identified further based on the user interactions of the other users of the user group.

5. The method of claim 1, further comprising:
displaying the user interest patterns of the user on a graphical user interface that allows the user to adjust an interest level of one or more of the user interest patterns;
receiving user input adjusting the interest level of one or more of the user interest patterns;
updating the set of knowledge elements of interest to the user based on the adjusted interest level; and
modifying the metadata changes being displayed based on the updated set of knowledge elements of interest to the user.

6. The method of claim 1, wherein the user interactions of the user further includes publication of knowledge elements by the user.

7. The method of claim 1, wherein the metadata changes include one or more of a new user comment, a new user rating, and content update associated with a knowledge element in set of knowledge elements of interest to the user.

8. A system comprising:
one or more processors; and
a memory coupled with and readable by the one or more processors, the memory configured to store a set of instructions which, when executed by the one or more processors, causes the one or more processors to:
monitor user interactions of a user with the data processing system, the user interactions including search queries submitted by the user and consumption of knowledge elements by the user;
identify user interest patterns of the user based on the user interactions;
determine a set of knowledge elements of interest to the user based on the user interest patterns;
detect metadata changes associated with the set of knowledge elements of interest to the user; and
display the metadata changes associated with the set of knowledge elements of interest to the user.

9. The system of claim 8, wherein the set of knowledge elements of interest to the user includes at least one knowledge element that the user did not consumed.

10. The system of claim 8, wherein the set of instructions further comprises instructions which, when executed by the one or more processors, cause the one or more processors to:
dynamically adjust the user interest patterns of the user based on subsequent user interactions of the user;
update the set of knowledge elements of interest to the user based on the adjusted user interest patterns; and
modify the metadata changes being displayed based on the updated set of knowledge elements of interest to the user.

11. The system of claim 8, wherein the set of instructions further comprises instructions which, when executed by the one or more processors, cause the one or more processors to:
monitor user interactions of other users of a user group that the user belongs to,
wherein the user interest patterns of the user are identified further based on the user interactions of the other users of the user group.

12. The system of claim 8, wherein the set of instructions further comprises instructions which, when executed by the one or more processors, cause the one or more processors to:
display the user interest patterns of the user on a graphical user interface that allows the user to adjust an interest level of one or more of the user interest patterns;
receive user input adjusting the interest level of one or more of the user interest patterns;
update the set of knowledge elements of interest to the user based on the adjusted interest level; and
modify the metadata changes being displayed based on the updated set of knowledge elements of interest to the user.

13. The system of claim 8, wherein the user interactions of the user further includes publication of knowledge elements by the user.

14. The system of claim 8, wherein the metadata changes include one or more of a new user comment, a new user rating, and content update associated with a knowledge element in set of knowledge elements of interest to the user.

15. A non-transitory computer-readable storage memory storing a plurality of instructions executable by one or more processors, the plurality of instructions comprising:
instructions that cause the one or more processors to monitor user interactions of a user with the data processing system, the user interactions including search queries submitted by the user and consumption of knowledge elements by the user;
instructions that cause the one or more processors to identify user interest patterns of the user based on the user interactions;
instructions that cause the one or more processors to determine a set of knowledge elements of interest to the user based on the user interest patterns;
instructions that cause the one or more processors to detect metadata changes associated with the set of knowledge elements of interest to the user; and
instructions that cause the one or more processors to display the metadata changes associated with the set of knowledge elements of interest to the user.

16. The non-transitory computer-readable storage memory of claim 15, wherein the set of knowledge elements of interest to the user includes at least one knowledge element that the user did not consume.

17. The non-transitory computer-readable storage memory of claim 15, wherein the plurality of instructions further comprises:
instructions that cause the one or more processors to dynamically adjust the user interest patterns of the user based on subsequent user interactions of the user;
instructions that cause the one or more processors to update the set of knowledge elements of interest to the user based on the adjusted user interest patterns; and
instructions that cause the one or more processors to modify the metadata changes being displayed based on the updated set of knowledge elements of interest to the user.

18. The non-transitory computer-readable storage memory of claim 15, wherein the plurality of instructions further comprises:
instructions that cause the one or more processors to monitor user interactions of other users of a user group that the user belongs to, wherein the user interest patterns of the user are identified further based on the user interactions of the other users of the user group.

19. The non-transitory computer-readable storage memory of claim 15, wherein the plurality of instructions further comprises:
instructions that cause the one or more processors to display the user interest patterns of the user on a graphical user interface that allows the user to adjust an interest level of one or more of the user interest patterns;
instructions that cause the one or more processors to receive user input adjusting the interest level of one or more of the user interest patterns;
instructions that cause the one or more processors to update the set of knowledge elements of interest to the user based on the adjusted interest level; and
instructions that cause the one or more processors to modify the metadata changes being displayed based on the updated set of knowledge elements of interest to the user.

20. The non-transitory computer-readable storage memory of claim 15, wherein the metadata changes include one or more of a new user comment, a new user rating, and a content update associated with a knowledge element in the set of knowledge elements of interest to the user.
